(19) United States
(12) Patent Application Publication
(10) Pub. No.: US 2025/0112407 A1
(43) Pub. Date: Apr. 3, 2025

(54) ELECTRICAL CONNECTION SYSTEM, PLUG, AND RECEPTACLE

(71) Applicant: Sumitomo Electric Industries, Ltd., Osaka (JP)

(72) Inventors: Yasunori ASANO, Osaka-shi (JP); Taisuke NAGASAKI, Osaka-shi (JP)

(73) Assignee: Sumitomo Electric Industries, Ltd., Osaka (JP)

(21) Appl. No.: 18/895,069

(22) Filed: Sep. 24, 2024

(30) Foreign Application Priority Data
Sep. 28, 2023 (JP) 2023-168342

(51) Int. Cl. H01R 13/646; H01R 12/71

(52) U.S. Cl. CPC H01R 13/646; H01R 12/716

(57) ABSTRACT

An electrical connection system includes a plug and a receptacle. The plug includes a plurality of first conductors and a plug housing including an inclined first end surface. The receptacle includes a plurality of second conductors and a receptacle housing including an inclined second end surface. The plug and the receptacle are configured to be coupled with each other, such that a first direction in which the first conductor extends intersects with a second direction in which the second conductor extends as a first connection mode. When the plug is coupled to the receptacle in the first connection mode, the first end surface faces the second end surface and each distal end portion of the plurality of the first conductors is electrically connected to the distal end portion of a corresponding second conductor among the plurality of the second conductors.

### CROSS REFERENCE

The present application claims priority based on Japanese Patent Application No. 2023-168342, filed on Sep. 28, 2023, the entire contents of which are incorporated herein by reference.

### TECHNICAL FIELD

The present disclosure relates to an electrical connection system, a plug, and a receptacle.

### BACKGROUND

JP2017-069166A discloses an electrical connector including a plurality of conductive wires arranged in parallel.

### SUMMARY

An electrical connection system according to an embodiment of the present disclosure includes a plug and a receptacle. The plug includes a plurality of first conductors each extending along a first direction, and a plug housing. The plug housing includes a first end surface inclined with respect to a plane orthogonal to the first direction, and a plurality of first storage portions storing the plurality of first conductors, respectively. Each distal end portion of the plurality of first conductors is exposed at the first end surface. The receptacle includes a plurality of second conductors each extending along a second direction, and a receptacle housing. The receptacle housing includes a second end surface inclined with respect to a plane orthogonal to the second direction, and a plurality of second storage portions storing the plurality of second conductors, respectively. Each distal end portion of the plurality of second conductors is exposed at the second end surface. The plug and the receptacle are configured to be coupled with each other such that the first direction intersects with the second direction as a first connection mode. When the plug is coupled to the receptacle in the first connection mode, the first end surface faces the second end surface and each distal end portion of the plurality of first conductors is electrically connected to the distal end portion of a corresponding second conductor among the plurality of second conductors.

### BRIEF DESCRIPTION OF THE DRAWINGS

FIG. 1 is a perspective view illustrating an electrical connection system according to an embodiment, and illustrates a first connection state in which a plug is connected to a receptacle in an L shape;

FIG. 2 is a cross-sectional view illustrating the first connection state of the connection system taken along line II-II illustrated in FIG. 1;

FIG. 3 is a perspective view illustrating the receptacle illustrated in FIG. 1;

FIG. 4 is a perspective view illustrating an example of an electrical wire and a conductor illustrated in FIG. 2;

FIG. 5 is a perspective view illustrating the electrical connection system according to an embodiment, and illustrates a second connection state in which the plug is linearly connected to the receptacle;

FIG. 6 is a cross-sectional view illustrating the second connection state of the connection system taken along line VI-VI illustrated in FIG. 5;

FIG. 7 is a cross-sectional view illustrating an electrical connection system according to a first modification, and illustrates a first connection state in which a plug is connected to a receptacle in an L shape;

FIG. 8A is a perspective view illustrating an example of a distal end portion of a conductor in the first modification, and FIG. 8B is a perspective view illustrating another example of the distal end portion of the conductor in the first modification;

FIG. 9 is a perspective view illustrating an electrical connection system according to a second modification, and illustrates a first connection state in which a plug is connected to a receptacle in an L shape;

FIG. 10 is a cross-sectional view illustrating the first connection state of the connection system taken along line X-X in FIG. 9;

FIG. 11 is a cross-sectional view illustrating a second connection state of the electrical connection system according to the second modification;

FIG. 12 is a cross-sectional view illustrating a first connection state of an electrical connection system according to a third modification; and

FIG. 13 is a cross-sectional view illustrating a first connection state of an electrical connection system according to a fourth modification.

### DETAILED DESCRIPTION

In a connection system of the electrical connector described in JP2017-069166A, a plurality of conductive wires stored in the electrical connector are connected to electrode pads of a counterpart electrical connector with terminals or contact portions which have the form different from the form of the plurality of conductive wires. When there is a portion different from the form of the conductive wire in the conduction path as described above, a mismatch of a high frequency characteristic impedance may occur in the portion. Further, in the connection system of the electrical connector described in JP2017-069166A, the electrical connectors are connected in a state where the conductive wire of the electrical connector and the electrode pad of the counterpart electrical connector extend in the same direction (horizontal direction). However, there is a demand for connecting the electrical connectors in a state where the conductor of the electrical connector and the conductor of the counterpart electrical connector extend in different directions (for example, directions orthogonal to each other).

According to the present disclosure, it is possible to increase the degree of freedom of connection while preventing the mismatch of the high frequency characteristic impedance.

### Description of Embodiments of Present Disclosure

First, contents of an embodiment of the present disclosure are listed and described.

(1) An electrical connection system according to an embodiment includes a plug and a receptacle. The plug includes a plurality of first conductors each extending along a first direction, and a plug housing. The plug housing includes a first end surface and a plurality of first storage portions. The first end surface is inclined with respect to a plane orthogonal to the first direction. The plurality of first storage portions respectively store the plurality of first conductors. Each distal end portion of the plurality of first conductors is exposed at the first end surface. The receptacle includes a plurality of second conductors each extending along a second direction, and a receptacle housing. The receptacle housing includes a second end surface and a plurality of second storage portions. The second end surface is inclined with respect to a plane orthogonal to the second direction. The plurality of second storage portions respectively store the plurality of second conductors. Each distal end portion of the plurality of second conductors is exposed at the second end surface. The plug and the receptacle are configured to be coupled with each other such that the first direction intersects with the second direction as a first connection mode. When the plug is coupled to the receptacle in the first connection mode, the first end surface faces the second end surface and each distal end portion of the plurality of first conductors is electrically connected to the distal end portion of a corresponding second conductor among the plurality of second conductors.

In the electrical connection system, each distal end portion of the plurality of first conductors is exposed at the first end surface, and each distal end portion of the plurality of second conductors is exposed at the second end surface. Each distal end portion of the plurality of first conductors is electrically connected to the distal end portion of a corresponding second conductor among the plurality of second conductors. According to the electrical connection system, there is no portion different from the form of the conductive wire in the conduction path, and thus it is possible to prevent the mismatch of the high frequency characteristic impedance. In addition, according to the electrical connection system, the plug and the receptacle are configured to be coupled with each other such that the first direction intersects with the second direction. When the plug is coupled to the receptacle, the first end surface faces the second end surface and each distal end portion of the plurality of first conductors is electrically connected to the distal end portion of the corresponding second conductor among the plurality of second conductors. According to such a configuration, the plug can be coupled to the receptacle in a state where the first conductor and the second conductor extend in different directions, and the degree of freedom of connection can be increased. Therefore, the above electrical connection system can increase the degree of freedom of connection while preventing the mismatch of the high frequency characteristic impedance.

(2) In the electrical connection system of (1), the plug and the receptacle may be configured to be coupled such that the first direction is along the second direction as a second connection mode. When the plug is coupled to the receptacle in the second connection mode, the first end surface may face the second end surface, and each distal end portion of the plurality of first conductors may be electrically connected to the distal end portion of a corresponding second conductor among the plurality of second conductors. In this case, the plug can be also connected to the receptacle in the second connection mode, in addition to the first connection mode. Therefore, the electrical connector system can further increase the degree of freedom of connection while preventing the mismatch of the high frequency characteristic impedance.

(3) In the electrical connection system of (2), one of the plug housing and the receptacle housing may further include at least one first engagement portion. The other one of the plug housing and the receptacle housing may further include at least one second engagement portion and at least one third engagement portion. The second engagement portion may be configured to be engageable with the first engagement portion when the plug is coupled to the receptacle such that the first direction intersects with the second direction. The third engagement portion may be configured to be engageable with the first engagement portion when the plug is coupled to the receptacle such that the first direction is along the second direction. In this case, the coupling between the plug and the receptacle can be fixed in both a case where the plug is coupled to the receptacle such that the first direction intersects with the second direction and a case where the plug is coupled to the receptacle such that the first direction is along the second direction.

(4) In the electrical connection system according to any one of (1) to (3), the first end surface of the plug housing may be inclined at 43 degrees to 47 degrees with respect to a plane orthogonal to the first direction. The second end surface of the receptacle housing may be inclined at 43 degrees to 47 degrees with respect to a plane orthogonal to the second direction. In this case, the plug can be easily coupled to the receptacle in the first connection mode, and the plug can also be easily coupled to the receptacle in the second connection mode.

(5) In the electrical connection system according to any one of (1) to (3), a total angle of a first inclination angle at which the first end surface of the plug housing is inclined with respect to a plane orthogonal to the first direction and a second inclination angle at which the second end surface of the receptacle housing is inclined with respect to a plane orthogonal to the second direction may be from 85 degrees to 95 degrees. In this case, the plug can be easily coupled to the receptacle in the first connection mode. Further, the plug can also be easily coupled to the receptacle in the second connection mode.

(6) In the electrical connection system according to any one of (1) to (5), the plurality of first conductors may include a plurality of signal conductors and a plurality of ground conductors connected to the ground. The plurality of signal conductors and the plurality of ground conductors may be arranged so as to be point-symmetric on the first end surface. In this case, even in a case where the plug is rotated and coupled to the receptacle such that the first end surface rotates by 180 degrees with respect to the second end surface, each of the plurality of signal conductors can be electrically connected to each of the second conductors, and the plurality of ground conductors can be electrically connected to the ground.

(7) In the electrical connection system according to any one of (1) to (6), the plurality of second conductors may extend along a third direction intersecting with the second direction after extending along the second direction and be exposed at the second end surface inside the receptacle housing. In this case, when the plug is coupled to the receptacle such that the first direction intersects with the second direction, the conduction path formed by the first conductor and the second conductor extends along the second direction, extends along the third direction, and then extends along the first direction. Thereby, the change in the extending direction of the conduction path becomes small as compared with the case where the conduction path extends along the first direction just after extending along the second direction, and thus the change in the cross-sectional shape becomes gentle. As a result, the change in impedance in the conduction path becomes gentle, deterioration of the transmission quality of the electric signal can be prevented.

(8) In the electrical connection system according to any one of (1) to (6), the plurality of first conductors may extend along the first direction and then extend along the third direction intersecting with the first direction to be exposed at the first end surface in the plug housing. In this case, when the plug is coupled to the receptacle such that the first direction intersects with the second direction, the conduction path formed from the first conductor and the second conductor extends along the first direction, extends along the third direction, and then extends along the second direction. Thereby, the change in the extending direction of the conduction path becomes small as compared with the case where the conduction path extends along the second direction just after extending along the first direction, and thus the change in the cross-sectional shape becomes gentle. As a result, the change in impedance in the conduction path becomes gentle, and thus deterioration of the transmission quality of the electric signal can be prevented.

(9) The electrical connection system according to any one of (1) to (6) may include an intervening member including a plurality of third conductors each extending along the third direction, and a sub housing. The sub housing may include a first principal surface and a second principal surface both intersecting with the third direction, and a plurality of third storage portions storing the plurality of third conductors respectively. The intervening member may be configured such that the first principal surface faces the first end surface and the second principal surface faces the second end surface when the plug is coupled to the receptacle so as to interpose the intervening member between the plug and the receptacle. The plurality of third conductors may extend from the first principal surface to the second principal surface, and may be configured to electrically connect each distal end portion of the plurality of first conductors to the distal end portion of a corresponding second conductor among the plurality of second conductors when the plug is coupled to the receptacle. In this case, when plug is coupled to the receptacle via the intervening member such that the first direction intersects with the second direction, the conduction path formed from the first conductor, the second conductor and the third conductor extends along the first direction, extends along the third direction, and then extends along the second direction. Thereby, the change in the extending direction of the conduction path becomes small as compared with the case where the conduction path extends along the second direction just after extending along the first direction, and thus the change in the cross-sectional shape becomes gentle. As a result, the change in impedance in the conduction path becomes gentle, and then deterioration of the transmission quality of the electric signal can be prevented.

(10) In the electrical connection system according to any one of (1) to (9), each distal end portion of the plurality of first conductors may be configured to be elastically deformable along the first direction when the plug is coupled to the receptacle. In this case, each distal end portion of the plurality of first conductors is in a physical contact with the distal end portion of the corresponding second conductor among the plurality of the second conductors while pressing the distal end portion of the corresponding second conductor, and thus, it is possible to more reliably electrically connect each distal end portion of the plurality of first conductors to the distal end portion of the corresponding second conductor among the plurality of the second conductors.

(11) In the electrical connection system according to any one of (1) to (10), each distal end portion of the plurality of second conductors may be configured to be elastically deformable along the second direction when the plug is coupled to the receptacle. In this case, each distal end portion of the plurality of second conductors is in a physical contact with the distal end portion of the corresponding first conductor among the plurality of the first conductors while pressing each of the distal end portions of the plurality of first conductors, and thus, it is possible to more reliably electrically connect each of the distal end portions of the plurality of the second conductors to each of the distal end portions of the plurality of the first conductors.

(12) In the electrical connection system according to any one of (1) to (11), each of the plurality of second conductors may include a groove formed at a distal end portion of the second conductor. In this case, when the plug is coupled to the receptacle, each distal end portion of the plurality of first conductors is brought into contact with the inner surface of the groove, so that each distal end portion of the plurality of first conductors can be electrically connected to the distal end portion of the corresponding second conductor among the plurality of second conductors. In this case, the groove may have a U shape or a V shape when viewed from a direction along the second end surface. According to this configuration, when the plug is coupled to the receptacle, each distal end portion of the plurality of first conductors is disposed at the bottom of the U-shaped or V-shaped groove and positioned by the inner surface of the groove, whereby each distal end portion of the plurality of first conductors can be more reliably electrically connected to the distal end portion of the corresponding second conductor among the plurality of second conductors. In addition, each of the plurality of second conductors may include an elastic body configured to be stretchable along the second direction. The elastic body may be configured to press the distal end portion of the second conductor along the second direction when the plug is coupled to the receptacle and each distal end portion of the plurality of first conductors comes into contact with the distal end portion of the corresponding second conductor among the plurality of second conductors. In this case, each distal end portion of the plurality of second conductors is pressed against the distal end portion of the corresponding first conductor among the plurality of first conductors, and thus it is possible to more reliably electrically connect each distal end portion of the plurality of second conductors to the distal end portion of the corresponding first conductor.

(13) A plug according to an embodiment is a plug connectable to a receptacle that includes a plurality of conductors and exposes each conductor from an end surface. The plug includes a plurality of first conductors each extending along a first direction, and a plug housing including a first end surface inclined with respect to a plane orthogonal to the first direction, and a plurality of first storage portions storing the plurality of first conductors, respectively. Each distal end portion of the plurality of first conductors is exposed at the first end surface. The first end surface is inclined with respect to a plane orthogonal to the first direction. The plug is configured to be coupled with the receptacle such that the first direction intersects with the second direction in which the plurality of conductors of the receptacle extends. According to the plug having such a configuration, it is possible to achieve operational effects similar to those of the electrical connection system described above.

(14) In the plug of (13), the plurality of first conductors may include a plurality of signal conductors and a plurality of ground conductors connected to the ground. The plurality of signal conductors and the plurality of ground conductors may be arranged so as to be point-symmetric on the first end surface. In this case, even in a case where the plug is rotated 180 degrees with respect to the receptacle and coupled to the receptacle, the plurality of signal conductors can be electrically connected to the plurality of conductors of the receptacle, and the plurality of ground conductors can be electrically connected to the ground of the receptacle.

(15) A receptacle according to an embodiment is a receptacle connectable to a plug including a plurality of conductors and exposing each conductor from an end surface. The receptacle includes a plurality of second conductors each extending along a second direction, and a receptacle housing including a second end surface inclined with respect to a plane orthogonal to the second direction and a plurality of second storage portions storing the plurality of second conductors, respectively. Each distal end portion of the plurality of second conductors is exposed at the second end surface. The second end surface is inclined with respect to a plane orthogonal to the second direction. The receptacle is configured to be coupled with the plug such that the second direction intersects with a first direction in which the plurality of conductors of the plug extend. According to the receptacle having such a configuration, it is possible to achieve operational effects similar to the above-described electrical connection system.

### DETAILS OF EMBODIMENT OF PRESENT DISCLOSURE

Specific examples of an electrical connection system according to an embodiment of the present disclosure will be described below with reference to the drawings. In the following description, the same reference signs will be used for the same elements or elements having the same functions, and the redundant description is omitted. Note that the present invention is not limited to these examples and is indicated by the claims and is intended to include all changes within the meaning and scope equivalent to the claims.

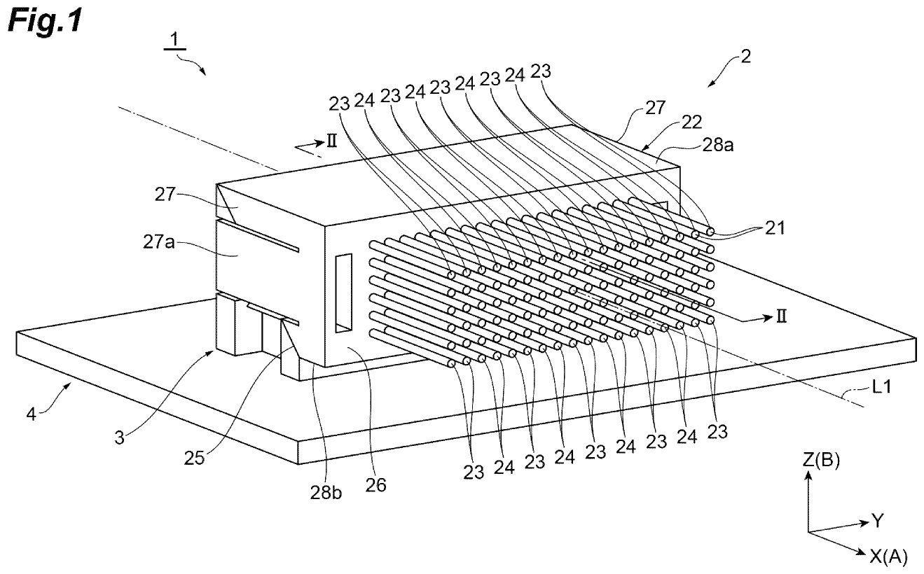

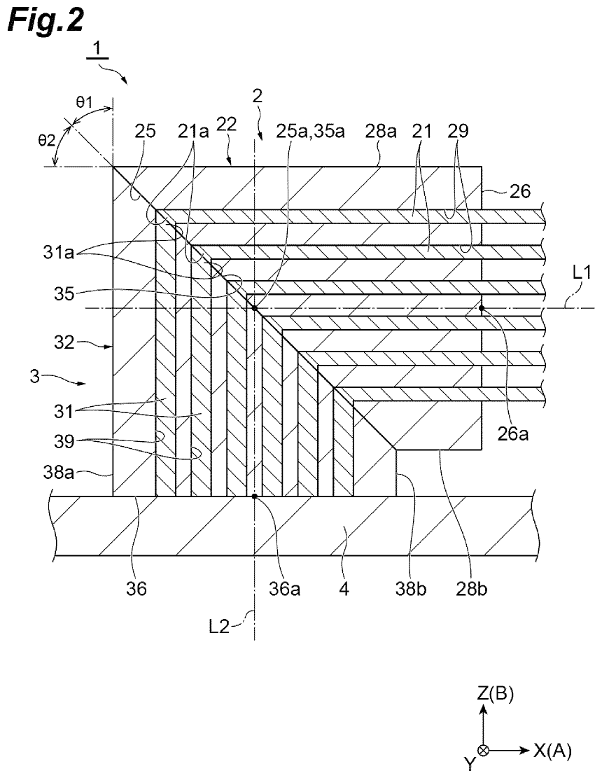

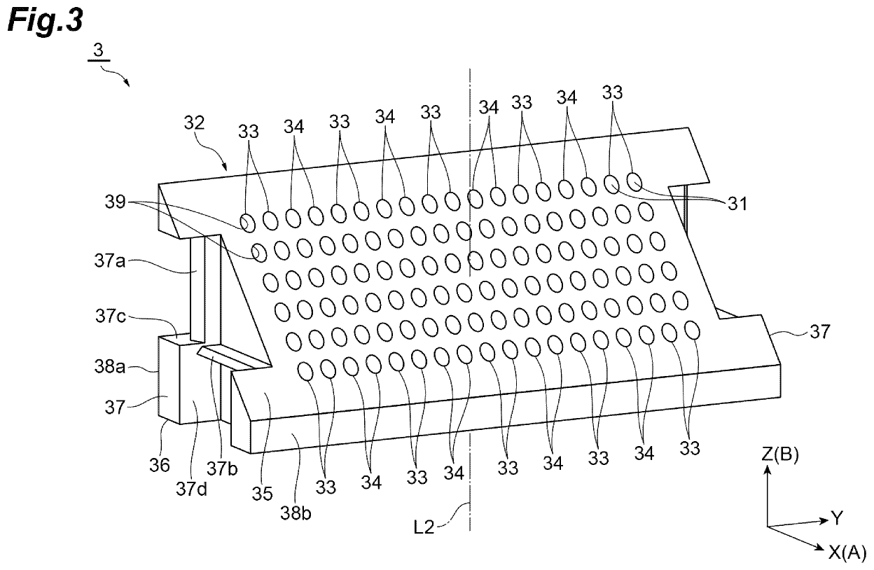

FIG. 1 is a perspective view illustrating an electrical connection system according to an embodiment, and illustrates a first connection state in which a plug is connected to a receptacle in an L shape. FIG. 2 is a cross-sectional view illustrating a first connection state of the connection system taken along line II-II illustrated in FIG. 1. FIG. 3 is a perspective view illustrating the receptacle. An electrical connection system 1 includes a plug 2, a receptacle 3, and a substrate 4. Hereinafter, a direction parallel to the substrate 4 is defined as an X direction and a Y direction, and a direction perpendicular to the substrate 4 is defined as a Z direction. In FIGS. 1 to 3, the X direction corresponds to a first direction A, and the Z direction corresponds to a second direction B.

In the electrical connection system 1, the plug 2 is attached to the substrate 4 via the receptacle 3. The plug 2 includes a plurality of electrical wires 21 (a plurality of first conductors) and a plug housing 22. The receptacle 3 includes a plurality of conductors 31 (a plurality of second conductors) and a receptacle housing 32.

The plurality of electrical wires 21 are members for transmitting electric power or electric signals. The plurality of electrical wires 21 includes a plurality of signal lines 23 (a plurality of signal conductors) and a plurality of ground lines 24 (a plurality of ground conductors). The signal lines 23 are formed of metal such as copper, for example. Each signal line 23 is electrically connected to a circuit in the substrate 4 through corresponding conductor 31 in the receptacle 3 when the plug 2 is coupled to the receptacle 3. The ground lines 24 are formed of metal such as copper, for example. Each ground line 24 is connected to the ground through corresponding conductor 31 in the receptacle 3 when the plug 2 is coupled to the receptacle 3.

The plurality of electrical wires 21 each extend along the X direction. The plurality of electrical wires 21 are arranged along the Y direction and the Z direction. For example, the plurality of electrical wires 21 include 108 electrical wires. In this case, 18 electrical wires arranged along the Y direction are arranged in 6 rows along the Z direction. In one example, in the plurality of electrical wires 21, a pair of signal lines 23 and a pair of ground lines 24 are alternately arranged along the Y direction. The plurality of electrical wires 21 are not limited to the above-described aspects, and other aspects can be appropriately selected.

The pair of adjacent signal lines 23 causes currents of opposite phases to each other to flow, and transmits signals by differential transmission in which signals are transmitted by a potential difference between the pair of signal lines 23. The plurality of electrical wires 21 are integrated by, for example, a covering member to form a flexible flat cable (FFC). The distance (distance between the centers) between the conductors of the plurality of electrical wires 21 is, for example, 0.6 mm.

The plug housing 22 includes a front end surface 25 (first end surface), a rear end surface 26, a pair of first side surfaces 27, a second side surface 28a, and a third side surface 28b. The front end surface 25 and the rear end surface 26 are surfaces extending in the Y direction and the Z direction. The front end surface 25 is inclined with respect to a plane orthogonal to the X direction. The front end surface 25 may be inclined at an angle θ1 (first inclination angle) with respect to a plane orthogonal to the X direction. The angle θ1 may be from 43 degrees to 47 degrees, may be 30 degrees or more, or may be 45 degrees, for example. The rear end surface 26 is located on the opposite side of the front end surface 25 in the X direction. The pair of first side surfaces 27 is surfaces extending in the X direction and the Z direction, and is arranged in the Y direction. The pair of first side surfaces 27 extends from the front end surface 25 to the rear end surface 26. A first engagement portion 27a is provided on each of the first side surfaces 27. For example, each of the first engagement portions 27a is a claw protruding from the front end surface 25 in the X direction. The second side surface 28a and the third side surface 28b are surfaces extending in the X direction and the Y direction, and are arranged side-by-side in the Z direction. The width of the second side surface 28a in the X direction is larger than the width of the third side surface 28b in the X direction.

The plug housing 22 further includes a plurality of through holes 29 (a plurality of first storage portions). Each of the plurality of through holes 29 penetrates the plug housing 22 along the X direction. The through hole 29 is, for example, a hole having a circular cross section, and is open at the front end surface 25 and the rear end surface 26. In the present embodiment, for example, 108 through holes 29 are formed in the plug housing 22. The plurality of through holes 29 are arranged along the Y direction and the Z direction. The inner diameter of each through hole 29 is the same as the outer diameter of the electrical wire 21 or slightly larger than the outer diameter of the electrical wire 21. The plurality of through holes 29 store the plurality of electrical wires 21, respectively. Distal end portions 21a of the plurality of electrical wires 21 are exposed respectively from the plurality of through holes 29 on the front end surface 25.

The plurality of signal lines 23 and the plurality of ground lines 24 are arranged point-symmetrically with respect to an imaginary straight line L1 passing through a center 25a of the front end surface 25 and a center 26a of the rear end surface 26. Therefore, the plurality of signal lines 23 and the plurality of ground lines 24 are arranged so as to be point-symmetric on the front end surface 25.

Next, the receptacle 3 will be described with reference to FIGS. 2 and 3. The plurality of conductors 31 are members for transmitting electric power or electric signals. The plurality of conductors 31 include a plurality of signal conductors 33 and a plurality of ground conductors 34. The signal conductors 33 are formed of metal such as copper, for example. The signal conductors 33 are electrically connected to a circuit in the substrate 4. The ground conductors 34 are made of metal such as copper, for example. The ground conductors 34 are electrically connected to the ground.

The plurality of conductors 31 each extend along the Z direction. The plurality of conductors 31 are arranged along the X direction and the Y direction. For example, the plurality of conductors 31 includes 108 conductors. 18 conductors arranged along the Y direction are arranged in 6 rows along the X direction. In one example, in the plurality of conductors 31, a pair of signal conductors 33 and a pair of ground conductors 34 are alternately arranged along the Y direction. The pair of adjacent signal conductor 33 causes currents of opposite phases to each other to flow, and transmits signals by differential transmission in which signals are transmitted by a potential difference between the pair of signal conductor 33. The distance (distance between the centers) between the conductors among the plurality of conductors 31 is, for example, 0.6 mm.

The receptacle housing 32 is configured to be coupled to the substrate 4. The receptacle housing 32 includes a front end surface 35 (second end surface), a rear end surface 36, a pair of first side surfaces 37, a second side surface 38a, and a third side surface 38b. The front end surface 35 and the rear end surface 36 are surfaces extending in the X direction and the Y direction. The front end surface 35 is inclined with respect to a plane orthogonal to the Z direction. The front end surface 35 may be inclined at an angle θ2 (second inclination angle) with respect to a plane orthogonal to the Z direction. The angle θ2 may be from 43 degrees to 47 degrees, may be 30 degrees or more, or may be 45 degrees, for example. The total angle of the angle θ1 of the front end surface 25 of the plug housing 22 and the angle θ2 of the front end surface 35 of the receptacle housing 32 may be from 85 degrees to 95 degrees, or may be, for example, 90 degrees. With such an angle, the plug 2 is coupled to the receptacle 3 in an L shape (first connection state). The rear end surface 36 is located on the opposite side of the front end surface 35 in the Z direction. The pair of first side surfaces 37 is surfaces extending in the X direction and the Z direction, and is arranged side-by-side in the Y direction. The pair of first side surfaces 37 extends from the front end surface 35 to the rear end surface 36. The second side surface 38a and the third side surface 38b are surfaces extending in the Y direction and the Z direction, and are arranged side-by-side in the X direction. The width of the second side surface 38a in the Z direction is larger than the width of the third side surface 38b in the Z direction.

Each of the first side surfaces 37 is provided with a second engagement portion 37a and a third engagement portion 37b. The second engagement portion 37a is configured to be engageable with the first engagement portion 27a of the plug housing 22. The third engagement portion 37b is configured to be engageable with the first engagement portion 27a. In the present embodiment, each of the second engagement portions 37a is disposed in a first recess 37c of the first side surface 37, and is, for example, a claw protruding from the first side surface 37 in the Y direction. Each of the third engagement portions 37b is disposed in a second recess 37d of the first side surface 37 and is, for example, a claw protruding from the first side surface 37 in the Y direction. That is, the first engagement portion 27a as a claw is hooked on the second engagement portion 37a or the third engagement portion 37b as a claw, whereby the first engagement portion 27a is engaged with the second engagement portion 37a or the third engagement portion 37b.

The receptacle housing 32 further includes a plurality of through holes 39 (a plurality of second storage portions). Each of the plurality of through holes 39 penetrates the receptacle housing 32 along the Z direction. Each through hole 39 is, for example, a hole having a circular cross section, and is open at the front end surface 35 and the rear end surface 36. In the present embodiment, for example, 108 through holes 39 are formed in the receptacle housing 32. The plurality of through holes 39 are arranged along the X direction and the Y direction. The inner diameter of each through hole 39 is the same as the outer diameter of the conductor 31 or slightly larger than the outer diameter of the conductor 31. The plurality of through holes 39 store the plurality of conductors 31, respectively. Distal end portions 31a of the plurality of conductors 31 are exposed respectively from each of the plurality of through holes 39 on the front end surface 35.

The plurality of signal conductors 33 and the plurality of ground conductors 34 are arranged point-symmetrically with respect to an imaginary straight line L2 passing through a center 35a of the front end surface 35 and a center 36a of the rear end surface 36. Therefore, the plurality of signal conductors 33 and the plurality of ground conductors 34 are arranged so as to be point-symmetric with respect to the center 35a on the front end surface 35.

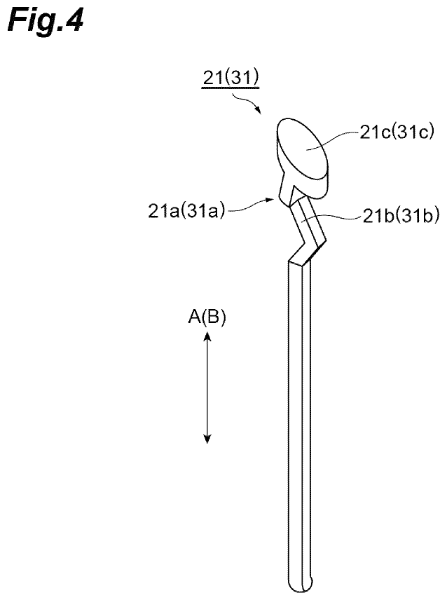

The distal end portion 21a of the electrical wire 21 and the distal end portion 31a of the conductor 31 will be described with reference to FIG. 4. FIG. 4 is a perspective view illustrating an example of the electrical wire 21 and the conductor 31. The distal end portion 21a is configured to be elastically deformable along the first direction A (X direction in FIG. 1) which is a longitudinal direction of the electrical wire 21 when the plug 2 is coupled to the receptacle 3. In the present embodiment, the distal end portion 21a has a plate spring 21b and an end surface 21c formed at the distal end of the plate spring 21b. The end surface 21c may be inclined at the angle θ1 with respect to a plane orthogonal to the Z direction similarly to the front end surface 25. That is, the end surface 21c may be inclined so as to coincide with the front end surface 25. The end surface 21c may be disposed so as to slightly protrude from the front end surface 25. The end surface 21c is movable in the first direction A by the plate spring 21b being elastically deformed in the first direction A.

The distal end portion 31a is configured to be elastically deformable along the second direction B (Z direction in FIG. 1) that is a longitudinal direction of the conductor 31 when the plug 2 is coupled to the receptacle 3. In the present embodiment, the distal end portion 31a has a plate spring 31b and an end surface 31c formed at the distal end portion of the plate spring 31b. The end surface 31c may be inclined at the angle θ2 with respect to a plane orthogonal to the Z direction similarly to the front end surface 35. That is, the end surface 31c may be inclined so as to coincide with the front end surface 35. The end surface 31c may be disposed so as to slightly protrude from the front end surface 35. The end surface 31c is movable in the second direction B by the plate spring 31b being elastically deformed in the second direction B.

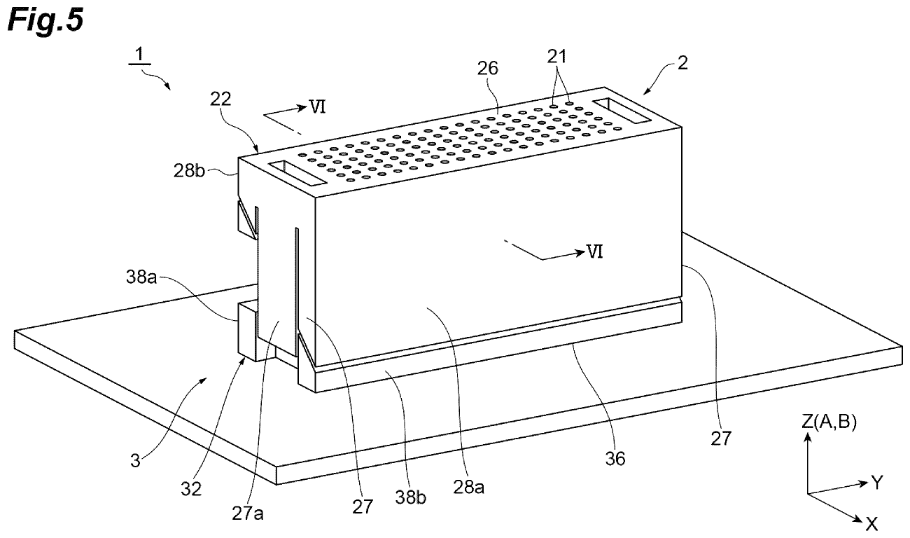

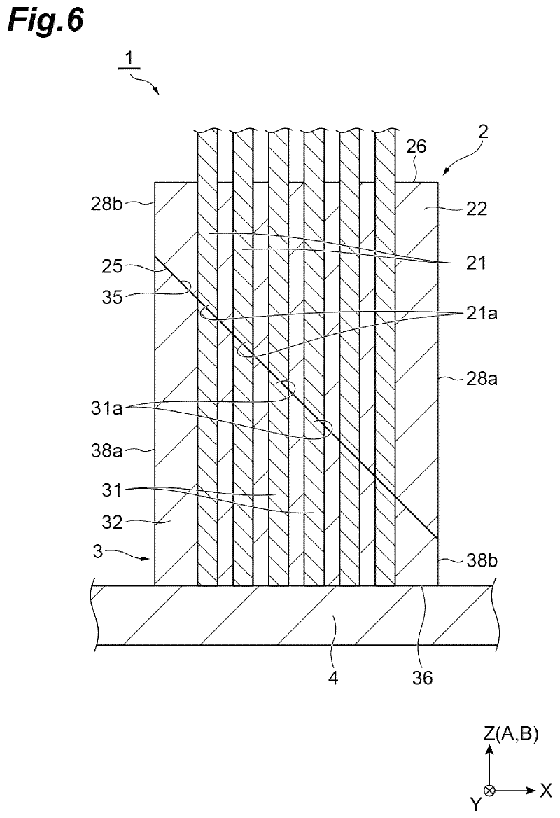

The coupling of the plug 2 and the receptacle 3 will be described with reference to FIGS. 1 and 2 and FIGS. 5 and 6. FIG. 5 is a perspective view illustrating the electrical connection system 1 according to an embodiment, and illustrates a second connection state in which the plug is linearly connected to the receptacle. FIG. 6 is a cross-sectional view of the connection system in the second connection state taken along line VI-VI illustrated in FIG. 5. In FIGS. 5 and 6, the Z direction corresponds to both the first direction A and the second direction B.

As illustrated in FIGS. 1 and 2, the plug 2 and the receptacle 3 are configured to be coupled to each other such that the first direction A intersects with the second direction B as a first connection state. When the plug 2 is coupled to the receptacle 3 such that the first direction A intersects with the second direction B, the first engagement portions 27a of the plug housing 22 are configured to be engageable with the second engagement portions 37a of the receptacle housing 32 (see FIG. 3). In this case, the front end surface 25 faces the front end surface 35. For example, the front end surface 25 and the front end surface 35 face each other in the Z direction, are parallel to each other, and overlap each other. The second side surface 28a intersects with the second side surface 38a. The third side surface 28b intersects with the third side surface 38b. Each distal end portion 21a of the plurality of electrical wires 21 is electrically connected to a distal end portion 31a of the corresponding conductor 31 of the plurality of conductors 31. Each distal end portions 21a of the electrical wires 21 is pressed from the conductor 31 in the Z direction and contracts in the X direction to push back the distal end portion 31a of the conductor 31. On the other hand, each distal end portion 31a of the conductors 31 is pressed from the electrical wire 21 in the X direction and contracts in the Z direction to push back the distal end portion 21a of the electrical wire 21.

As illustrated in FIGS. 5 and 6, the plug 2 and the receptacle 3 is configured to be coupled to each other such that the first direction A is along the second direction B as a second connection state. That is, the plug 2 can be connected to the receptacle 3 in different connection states. When the plug 2 is coupled to the receptacle 3 such that the first direction A is along the second direction B, the first engagement portions 27a of the plug housing 22 is configured to be engageable with the third engagement portions 37b of the receptacle housing 32 (see FIG. 3). In this case, the front end surface 25 faces the front end surface 35. For example, the front end surface 25 and the front end surface 35 face each other in the Z direction, are parallel to each other, and overlap each other. The second side surface 28a is flush with the third side surface 38b. The third side surface 28b is flush with the second side surface 38a. Each distal end portion 21a of the plurality of electrical wires 21 is electrically connected to the distal end portion 31a of the corresponding conductor 31 among the plurality of conductors 31. Each distal end portion 21a of the electrical wires 21 is pressed from the conductor 31 in the Z direction and contracts in the Z direction to push back the distal end portion 31a of the conductor 31. On the other hand, each distal end portion 31a of the conductor 31 is pressed from the electrical wire 21 in the Z direction and contracts in the Z direction to push back the distal end portion 21a of the electrical wire 21.

As described above, the plug 2 and the receptacle 3 is configured to be coupled to each other in both a case where the first direction A intersects with the second direction B (first connection state) and a case the first direction A is along the second direction B (second connection state).

As described above, in the electrical connection system 1 according to the present embodiment, each distal end portions 21a of the plurality of electrical wires 21 is exposed at the front end surface 25, and each distal end portion 31a of the plurality of conductors 31 is exposed at the front end surface 35. Each distal end portion 21a of the plurality of electrical wires 21 is electrically connected to the distal end portion 31a of the corresponding conductor 31 among the plurality of conductors 31. According to the electrical connection system 1, there is no portion different from the form of the conductive wire in the conduction path, and thus it is possible to prevent the mismatch of the high frequency characteristic impedance. Further, according to the electrical connection system 1, the plug 2 and the receptacle 3 are configured to be coupled to each other such that the first direction A intersects with the second direction B. When the plug 2 is coupled to the receptacle 3, the front end surface 25 faces the front end surface 35, and each distal end portion 21a of the plurality of electrical wires 21 is electrically connected to the distal end portion 31a of the corresponding conductor 31 among the plurality of conductors 31. According to such a configuration, the plug 2 can be connected to the receptacle 3 in a state where the electrical wires 21 and the conductors 31 extend in different directions, and the degree of freedom of connection can be increased. Therefore, the electrical connection system 1 can increase the degree of freedom of connection while preventing the mismatch of the high frequency characteristic impedance.

In the electrical connection system 1, the plug 2 and the receptacle 3 are configured to be coupled such that the first direction A is along the second direction B as the second connection mode. When the plug 2 is coupled to the receptacle 3 in the second connection mode, the front end surface 25 faces the front end surface 35 and each distal end portion 21a of the plurality of electrical wires 21 is electrically connected to the distal end portion 31a of the corresponding conductor among the plurality of conductors 31. Thereby, the plug 2 can be connected to the receptacle 3 in the second connection mode, in addition to the first connection mode. Therefore, the electrical connection system 1 can further increase the degree of freedom of connection while preventing the mismatch of the high frequency characteristic impedance.

In the electrical connection system 1, the plug housing 22 further includes first engagement portions 27a, and the receptacle housing 32 further includes second engagement portions 37a and third engagement portions 37b. The second engagement portions 37a engage with the first engagement portions 27a when the plug 2 is coupled to the receptacle 3 such that the first direction A intersects with the second direction B. The third engagement portions 37b engage with the first engagement portions 27a when the plug 2 is coupled to the receptacle 3 such that the first direction A is along the second direction B. Accordingly, the electrical connection between the electrical wires 21 and the conductors 31 can be realized by a set of the plug 2 and the receptacle 3 in both a case where the plug 2 is coupled to the receptacle 3 such that the first direction A intersects with the second direction B and a case where the plug 2 is coupled to the receptacle 3 such that the first direction A is along the second direction B.

In the electrical connection system 1, the front end surface 25 of the plug housing 22 is inclined at 43 degrees to 47 degrees with respect to a plane orthogonal to the first direction A. The front end surface 35 of the receptacle housing 32 is inclined at 43 degrees to 47 degrees with respect to a plane orthogonal to the second direction B. Thereby, the plug 2 can be easily coupled to the receptacle 3 in the first connection mode, and the plug 2 can also be easily coupled to the receptacle 3 in the second connection mode.

In the electrical connection system 1, the plurality of electrical wires 21 include a plurality of signal lines 23 and a plurality of ground lines 24 connected to the ground. The plurality of signal lines 23 and the plurality of ground lines 24 are arranged so as to be point-symmetric on the front end surface 25. In this case, even in a case where the plug 2 is rotated and coupled to the receptacle 3 such that the front end surface 25 rotates by 180 degrees with respect to the front end surface 35, the plurality of signal lines 23 can be electrically connected to the corresponding signal conductors 33 among the plurality of signal conductors 33, and the plurality of ground lines 24 can be electrically connected to the ground.

In the electrical connection system 1, each distal end portion 21a of the plurality of electrical wires 21 is configured to be elastically deformable along the first direction A when the plug 2 is coupled to the receptacle 3. In this case, each distal end portion 21a of the plurality of electrical wires 21 is in a physical contact with the distal end portion 31a of the corresponding conductor 31 among the plurality of the conductors 31 while pressing the distal end portion 31a of the corresponding conductor 31. Thus, it is possible to more reliably electrically connect each distal end portion 21a of the plurality of electrical wires 21 to each distal end portion 31a of the plurality of the conductors 31.

In the electrical connection system 1, each distal end portions 31a of the plurality of conductors 31 is configured to be elastically deformable along the second direction B when the plug 2 is coupled to the receptacle 3. In this case, each distal end portion 31a of the plurality of conductors 31 is in a physical contact with the distal end portion 21a of the corresponding electrical wire 21 among the plurality of electrical wires 21 while pressing the distal end portion 21a of the corresponding electrical wire 21. Thus, it is possible to more reliably electrically connect each distal end portions 31a of the plurality of the conductors 31 to each distal end portions 21a of the plurality of the electrical wires 21.

In the electrical connection system 1, each of the plurality of through holes 29 of the plug housing 22 extends along the first direction A and penetrates the plug housing 22. In this case, the plurality of through holes 29 hold the plurality of electrical wires 21, and thus each distal end portion 21a of the plurality of electrical wires 21 can be more accurately positioned with respect to the distal end portion 31a of the corresponding conductor 31 among the plurality of conductors 31. This makes it possible to prevent deterioration of transmission quality of the electric signals.

In the electrical connection system 1, each of the plurality of through holes 39 of the receptacle housing 32 extends along the second direction B and penetrates the receptacle housing 32. In this case, the plurality of through holes 39 hold the plurality of conductors 31, and thus each distal end portion 31a of the plurality of conductors 31 can be more accurately positioned with respect to the distal end portion 21a of the corresponding electrical wire 21 among the plurality of electrical wires 21. This makes it possible to prevent deterioration of transmission quality of the electric signals.

Hereinabove, although the embodiment of the present disclosure has been described in detail, the present disclosure is not limited to the above embodiment, and can be applied to various embodiments. For example, in the above embodiment, each distal end portion 21a of the plurality of electrical wires 21 is configured to be elastically deformable along the first direction A, but may not be configured to be elastically deformable. Each distal end portion 31a of the plurality of conductors 31 is configured to be elastically deformable along the second direction B, but may not be configured to be elastically deformable.

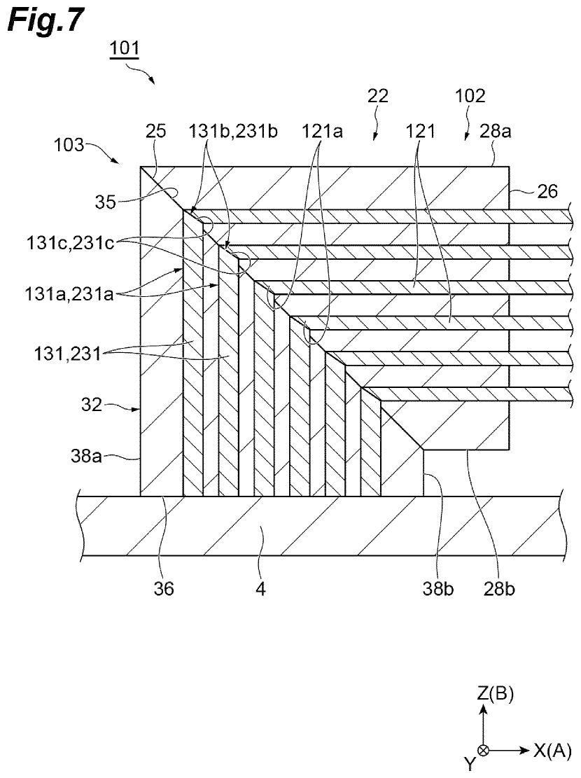

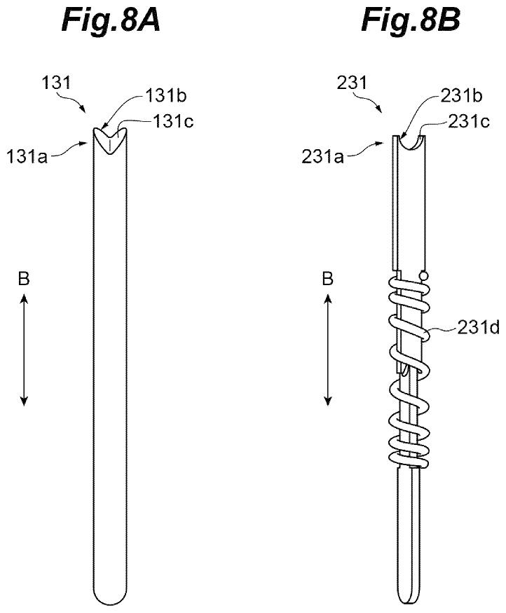

FIG. 7 is a cross-sectional view illustrating an electrical connection system according to a first modification, and illustrates a first connection state. FIG. 8A and FIG. 8B are perspective views illustrating other examples of a distal end portion of a conductor according to the first modification. An electrical connection system 101 according to the first modification includes a plug 102, a receptacle 103, and a substrate 4. The plug 102 may have a plurality of electrical wires 121 instead of the plurality of electrical wires 21. The plug 102 may have a plug housing 22 similar to the plug 2. Each distal end portion 121a of the plurality of electrical wires 121 may not be configured to be elastically deformable. The receptacle 103 may have a plurality of conductors 131 or a plurality of conductors 231 instead of the plurality of conductors 31. Similarly to the receptacle 3, the receptacle 103 may have a receptacle housing 32.

As illustrated in FIG. 8A, each of the plurality of conductors 131 includes a groove 131b formed in a distal end portion 131a of the conductor 131. The groove 131b may have a V shape when viewed from a direction along the front end surface 35 of the receptacle housing 32. As illustrated in FIG. 8B, each of the plurality of conductors 231 may include a groove 231b formed in a distal end portion 231a of the conductor 231. The groove 231b may have a U shape when viewed from a direction along the front end surface 35 of the receptacle housing 32. Each of the plurality of conductors 231 may include an elastic body 231d configured to be stretchable along the second direction B. The elastic body 231d is configured to press the distal end portion 231a of the conductor 231 along the second direction B when the plug 102 is fitted into the receptacle 103 and each distal end portion 121a of the plurality of electrical wires 121 comes into contact with the distal end portion 231a of the corresponding conductor 231 among the plurality of conductors 231. As illustrated in FIG. 7, when the plug 102 is coupled to the receptacle 103, each distal end portion 121a of the plurality of electrical wires 121 comes into contact with each inner surface 131c, 231c of the grooves 131b, 231b.

In the electrical connection system 101 according to the first modification, the plurality of conductors 131, 231 include the grooves 131b, 231b formed in the distal end portions 131a, 231a of the conductors 131, 231, respectively. In this case, when the plug 102 is coupled to the receptacle 103, each distal end portion 121a of the plurality of electrical wires 121 is brought into contact with each inner surface 131c, 231c of the groove 131b, 231b, so that each distal end portion 121a of the plurality of electrical wires 121 can be electrically connected to each distal end portion 131a, 231a of the corresponding conductor 131, 231 among the plurality of conductors 131, 231.

In the electrical connection system 101 according to the first modification, each groove 131b, 231b is U-shaped or V-shaped when viewed from a direction along the front end surface 35 of the receptacle housing 32. In this case, when the plug 102 is coupled to the receptacle 103, each distal end portion 121a of the plurality of electrical wires 121 is disposed at the bottom of the U-shaped or V-shaped groove 131b, 231b, and positioned by the inner surface 131c, 231c of the groove 131b, 231b, so that it is possible to more reliably electrically connect each distal end portion 121a of the plurality of electrical wires 121 to the distal end portion 131a, 231a of the corresponding conductor 131, 231 among the plurality of conductors 131, 231.

In the electrical connection system 101 according to the first modification, each distal end portion 121a of the plurality of electrical wires 121 is in contact with the inner surface 131c, 231c of the groove 131b, 231b when the plug 102 is coupled to the receptacle 103. In this case, each distal end portion 121a of the plurality of electrical wires 121 can be electrically connected to the distal end portion 131a, 231a of the corresponding conductor 131, 231 among the plurality of conductors 131, 231.

In the electrical connection system 101 according to the first modification, each of the plurality of conductors 231 may include the elastic body 231d configured to be stretchable along the second direction B. The elastic body 231d is configured to press the distal end portion 231a of the conductor 231 along the second direction B when the plug 102 is coupled to the receptacle 103 and each distal end portion 121a of the plurality of electrical wires 121 comes into contact with the distal end portion 231a of the conductor 231 among the plurality of conductors 231. In this case, since each distal end portion 231a of the plurality of conductors 231 is pressed against the distal end portion 121a of the corresponding electrical wire 121 among the plurality of electrical wires 121, it is possible to more reliably electrically connect each distal end portion 231a of the plurality of conductors 231 to each distal end portion 121a of the plurality of electrical wires 121.

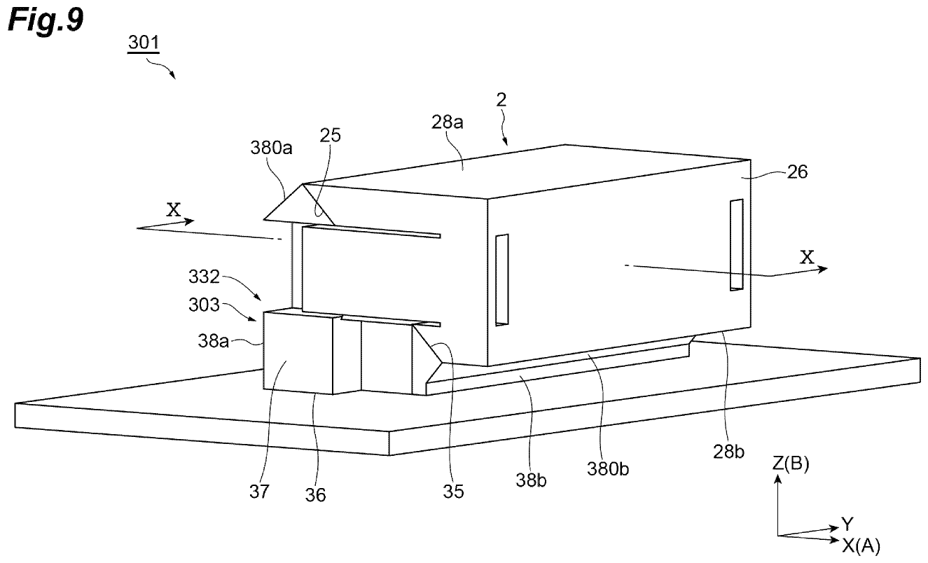

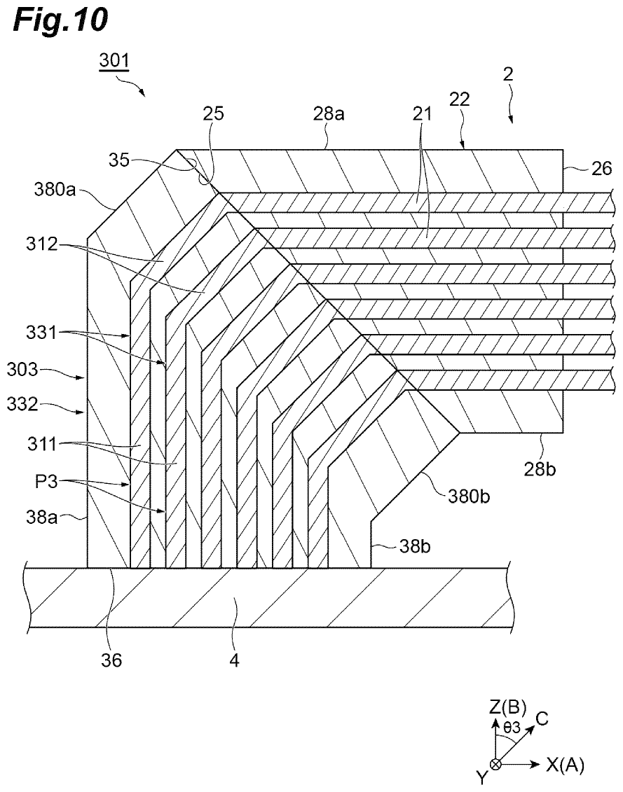

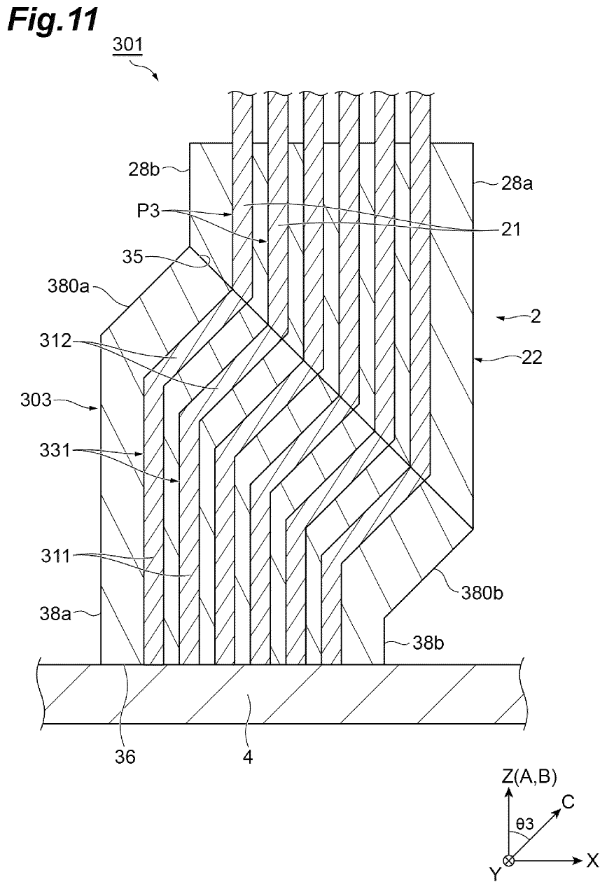

In the above embodiment and each modification, the plurality of conductors 31 extend only in the second direction B, but the present disclosure is not limited thereto. The plurality of conductors 31 may extend along a third direction intersecting with the first direction A and the second direction B after extending in the second direction B. FIG. 9 is a perspective view illustrating an electrical connection system 301 according to a second modification, and illustrates a first connection state. FIG. 10 is a cross-sectional view of the connection system 301 in the first connection state taken along line X-X illustrated in FIG. 9. FIG. 11 is a cross-sectional view illustrating a second connection state of the connection system 301 according to the second modification. The electrical connection structure 301 includes a plug 2, a receptacle 303, and a substrate 4. Hereinafter, a direction intersecting with the X direction and the Z direction is referred to as a third direction C. The third direction C intersects with the Z direction at an angle θ3. The angle θ3 may be 43 degrees or more and 47 degrees or less, and is, for example, 45 degrees.

The receptacle 303 includes a plurality of conductors 331 and a receptacle housing 332. The receptacle housing 332 is different from the receptacle housing 32 in further including a pair of inclined surfaces 380a and 380b. The pair of inclined surfaces 380a and 380b is planes intersecting with the X direction and the Z direction, and extend along the Y direction and the third direction C. The inclined surface 380a intersects with the second side surface 38a. The inclined surface 380b intersects with the third side surface 38b. The plurality of conductors 331 are provided inside the receptacle housing 332. Each of the plurality of conductors 331 include a first portion 311 extending along the second direction B and a second portion 312 extending along the third direction C so as to be orthogonal to the front end surface 35.

As illustrated in FIGS. 9 and 10, when the plug 2 is coupled to the receptacle 303 such that the first direction A intersects with the second direction B (first connection state), the second side surface 28a intersect with the inclined surface 380a, and the third side surface 28b intersects with the inclined surface 380b. As illustrated in FIG. 11, when the plug 2 is coupled to the receptacle 303 such that the first direction A is along the second direction B (second connection state), the second side surface 28a intersect with the inclined surface 380b, and the third side surface 28b intersects with the inclined surface 380a. In both cases, each conductor 331 and each electrical wire 21 form a conduction path P3. The conduction path P3 extends the second direction B, extends along the third direction C, and then extends along the first direction A.

In the electrical connection system 301 according to the second modification, when the plug 2 is coupled to the receptacle 103 such that the first direction A intersects the second direction B, the conduction path P3 formed by the electrical wire 21 and the conductor 331 extends along the second direction B, extends along the third direction C, and then extends along the first direction A. As a result, the change in the extending direction of the conduction path becomes small as compared with the case where the conduction path extends along the first direction A after extending along the second direction B, and thus the change in the cross-sectional shape becomes gentle. As a result, the change in impedance in the conduction path becomes gentle, and thus deterioration of the transmission quality of the electric signal can be prevented.

As described above, in the electrical connection system 301 according to the second modification, in both the case where the plug 2 is coupled to the receptacle 303 such that the first direction A intersects with the second direction B and the case where the plug 2 is coupled to the receptacle 303 such that the first direction A is along the second direction B, the conduction path P3 is bent by 45 degrees in the receptacle housing 332 and then bent by 45 degrees in the front end surfaces 25 and 35. Therefore, the change in direction in the conduction path becomes gentle. As a result, the change in impedance in the conduction path P3 becomes gentle, and thus deterioration of the transmission quality of the electric signal can be further prevented.

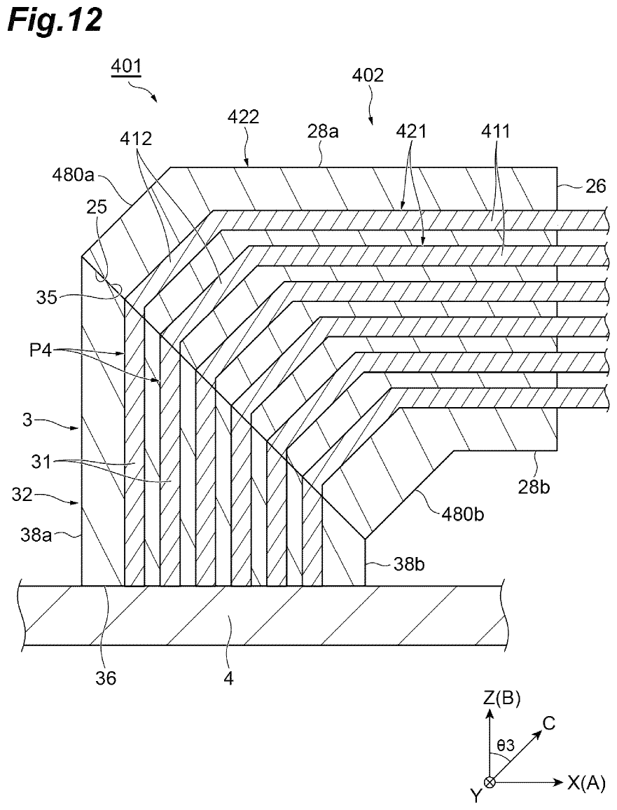

In the above embodiment, the plurality of electrical wires 21 extend only in the first direction A, but the present disclosure is not limited thereto. The plurality of electrical wires 21 may extend along the third direction C after extending in the first direction A. FIG. 12 is a cross-sectional view illustrating an electrical connection system 401 according to a third modification, and illustrates a first connection state. The electrical connection system 401 includes a plug 402, a receptacle 3, and a substrate 4.

The plug 402 includes a plurality of electrical wires 421 and a plug housing 422. The plug housing 422 is different from the plug housing 22 in further including a pair of inclined surfaces 480a and 480b. The pair of inclined surfaces 480a and 480b is planes intersecting with the X direction and the Z direction, and extend along the Y direction and the third direction C. The inclined surface 480a intersects with the second side surface 28a. The inclined surface 480b intersects with the third side surface 28b. The plurality of electrical wires 421 are provided inside the plug housing 422. Each of the plurality of electrical wires 421 include a first portion 411 extending along the first direction A and a second portion 412 extending along the third direction C so as to be orthogonal to the front end surface 25.

When the plug 402 is coupled to the receptacle 3 such that the first direction A intersects with the second direction B (first connection state), the inclined surface 480a intersects with the second side surface 38a, and the inclined surface 480b intersects with the third side surface 38b. When the plug 402 is coupled to the receptacle 3 such that the first direction A is along the second direction B (second connection state), the inclined surface 480b intersects with the second side surface 38a, and the inclined surface 480a intersects with the third side surface 38b (not illustrated, but refer to FIG. 11). In both cases, each conductor 31 and each electrical wire 421 form a conduction path P4. The conduction path P4 extends along the first direction A, extends along the third direction C, and then extends along the second direction B.

In the electrical connection system 401 according to the third modification, when the plug 402 is coupled to the receptacle 3 such that the first direction A intersects with the second direction B, the conduction path P4 formed by the electrical wire 421 and the conductor 31 extends along the first direction A, extends along the third direction C, and then extends along the second direction B. As a result, the change in the extending direction of the conduction path becomes small as compared with the case where the conduction path extends along the second direction B after extending along the first direction A, and thus the change in the extending direction becomes gentle. As a result, the change in impedance in the conduction path becomes gentle, and thus deterioration of the transmission quality of the electric signal can be further prevented.

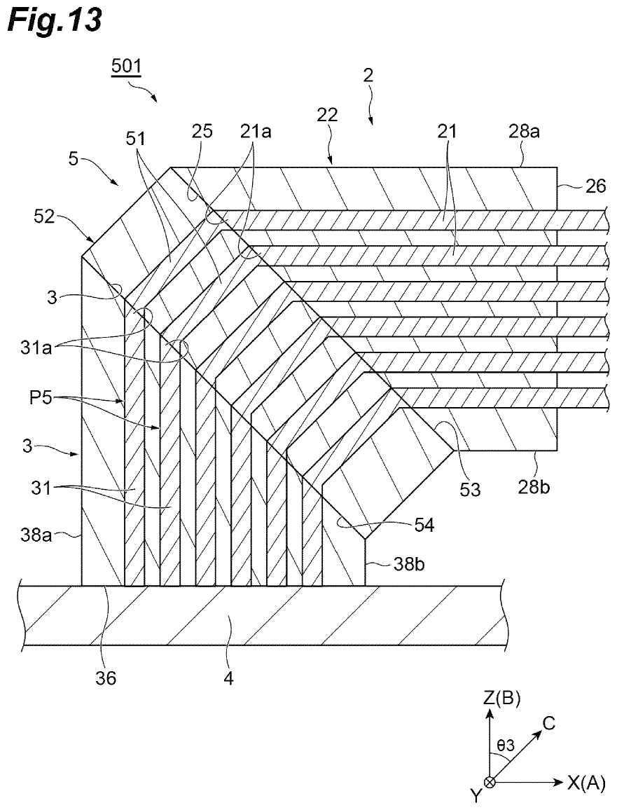

In the above embodiment, the electrical connection system 1 may further include an intervening member that is interposed between the plug 2 and the receptacle 3 and has intervening conductors each extending along the third direction C. FIG. 13 is a cross-sectional view illustrating an electrical connection system according to a fourth modification, and illustrates a first connection state. An electrical connection system 501 includes a plug 2, a receptacle 3, a substrate 4, and an intervening member 5.

The intervening member 5 includes a plurality of intervening conductors 51 (a plurality of third conductors) and a sub housing 52. The plurality of intervening conductors 51 each extend along the third direction C. The sub housing 52 includes a first principal surface 53 and a second principal surface 54 both intersecting with the third direction C. The intervening member 5 is interposed between the plug 2 and the receptacle 3 when the plug 2 is coupled to the receptacle 3. In this case, the first principal surface 53 faces and overlaps the front end surface 25 of the plug housing 22 in the third direction C. The second principal surface 54 faces and overlaps the front end surface 35 of the receptacle housing 32 in the third direction C. The plurality of intervening conductors 51 extend from the first principal surface 53 to the second principal surface 54. When the plug 2 is coupled to the receptacle 3, the plurality of intervening conductors 51 electrically connect each distal end portion 21a of the plurality of electrical wires 21 to the distal end portion 31a of the corresponding conductor 31 among the plurality of conductors 31.

In the electrical connection system 501 according to the fourth modification, when the plug 2 is coupled to the receptacle 3 via the intervening member 5 such that the first direction A intersects with the second direction B (first connection state), a conduction path P5 formed from the electrical wire 21, the intervening conductor 51, and the conductor 31 extends along the first direction A, extends along the third direction C, and then extends along the second direction B. As a result, the change in the extending direction of the conduction path becomes small as compared with the case where the conduction path extends along the second direction B after extending along the first direction A. As a result, the change in impedance in the conduction path becomes gentle, and thus degradation of the transmission quality of the electric signal can be prevented.

In the above embodiment, one of the plug housing 22 and the receptacle housing 32 may include the first engagement portion 27a, and the other one of the plug housing 22 and the receptacle housing 32 may include the second engagement portion 37a and the third engagement portion 37b. For example, the receptacle housing 32 may include a configuration corresponding to the first engagement portions 27a, and the plug housing 22 may include a configuration corresponding to the second engagement portions 37a and the third engagement portions 37b.

In the above embodiment, the first engagement portions 27a and the second engagement portions 37a may be engageable with each other, and the first engagement portions 27a and the third engagement portions 37b may be engageable with each other. For example, the first engagement portion 27a may be a guide pin provided on the front end surface 25 of the plug housing 22, and the second engagement portion 37a and the third engagement portion 37b may be holes provided in the front end surface 35 of the receptacle housing 32. In this case, the first engagement portion 27a may be engaged with the second engagement portion 37a or the third engagement portion 37b by being inserted into the second engagement portion 37a or the third engagement portion 37b.

In the above embodiment, the plurality of signal lines 23 and the plurality of ground lines 24 are arranged point-symmetrically with respect to the imaginary straight line L1 passing through the center 25a of the front end surface 25 and the center 26a of the rear end surface 26, but the present disclosure is not limited thereto. For example, the plurality of signal lines 23 and the plurality of ground lines 24 may be arranged point-symmetrically with respect to a predetermined point on the front end surface 25.

What is claimed is:

1. An electrical connection system, comprising:
a plug including a plurality of first conductors each extending along a first direction and a plug housing, wherein the plug housing includes a first end surface inclined with respect to a plane orthogonal to the first direction and a plurality of first storage portions storing the plurality of first conductors respectively, wherein each distal end portion of the plurality of first conductors is exposed at the first end surface; and
a receptacle including a plurality of second conductors each extending along a second direction and a receptacle housing, wherein the receptacle housing includes a second end surface inclined with respect to a plane orthogonal to the second direction and a plurality of second storage portions storing the plurality of second conductors respectively, wherein each distal end portion of the plurality of second conductors is exposed at the second end surface,
wherein the plug and the receptacle are configured to be coupled to each other such that the first direction intersects with the second direction as a first connection mode, and
wherein, when the plug is coupled to the receptacle in the first connection mode, the first end surface faces the second end surface and each distal end portion of the plurality of first conductors is electrically connected to the distal end portion of a corresponding second conductor among the plurality of second conductors.

2. The electrical connection system according to claim 1,
wherein the plug and the receptacle are configured to be coupled with each other such that the first direction is along the second direction as a second connection mode, and
wherein, when the plug is coupled to the receptacle in the second connection mode, the first end surface faces the second end surface and each distal end portion of the plurality of first conductors is electrically connected to the distal end portion of a corresponding second conductor among the plurality of second conductors.

3. The electrical connection system according to claim 2,
wherein one of the plug housing and the receptacle housing further includes at least one first engagement portion, and
wherein the other of the plug housing and the receptacle housing includes:
at least one second engagement portion configured to be engageable with the first engagement portion when plug is coupled to the receptacle such that the first direction intersects with the second direction; and
at least one third engagement portion configured to be engageable with the first engagement portion when the plug is coupled to the receptacle such that the first direction is along the second direction.

4. The electrical connection system according to claim 1,
wherein the first end surface of the plug housing is inclined at 43 degrees to 47 degrees with respect to a plane orthogonal to the first direction, and the second end surface of the receptacle housing is inclined at 43 degrees to 47 degrees with respect to a plane orthogonal to the second direction.

5. The electrical connection system according to claim 1,
wherein a total angle of a first inclination angle at which the first end surface of the plug housing is inclined with respect to a plane orthogonal to the first direction and a second inclination angle at which the second end surface of the receptacle housing is inclined with respect to a plane orthogonal to the second direction is from 85 degrees to 95 degrees.

6. The electrical connection system according to claim 1,
wherein the plurality of first conductors include a plurality of signal conductors and a plurality of ground conductors connected to a ground, and
wherein the plurality of signal conductors and the plurality of ground conductors are arranged so as to be point-symmetric on the first end surface.

7. The electrical connection system according to claim 1,
wherein the plurality of second conductors extend along a third direction intersecting with the second direction after extending along the second direction and are exposed at the second end surface inside the receptacle housing.

8. The electrical connection system according to claim 1,
wherein the plurality of first conductors extend along a third direction intersecting with the first direction after extending along the first direction and are exposed at the first end surface inside the plug housing.

9. The electrical connection system according to claim 1, further comprising:
an intervening member including a plurality of third conductors each extending along a third direction and a sub housing, wherein the sub housing includes a first principal surface and a second principal surface both intersecting with the third direction and a plurality of third storage portions storing the plurality of third conductors respectively,
wherein the intervening member is configured such that the first principal surface faces the first end surface and the second principal surface faces the second end surface when the plug is coupled to the receptacle so as to interpose the intervening member between the plug and the receptacle, and
wherein the plurality of third conductors extend from the first principal surface to the second principal surface, and are configured to electrically connect each distal end portion of the plurality of first conductors to the distal end portion of a corresponding second conductor among the plurality of second conductors when the plug is coupled to the receptacle.

10. The electrical connection system according to claim 1,
wherein each distal end portion of the plurality of first conductors is configured to be elastically deformable along the first direction when the plug is coupled to the receptacle.

11. The electrical connection system according to claim 1,
wherein each distal end portion of the plurality of second conductors is configured to be elastically deformable along the second direction when the plug is coupled to the receptacle.

12. The electrical connection system according to claim 1,
wherein each of the plurality of second conductors includes a groove formed at a distal end portion of the second conductor.

13. A plug connectable to a receptacle including a plurality of conductors and exposing each conductor from an end surface, the plug comprising:
a plurality of first conductors each extending along a first direction; and
a plug housing including a first end surface inclined with respect to a plane orthogonal to the first direction, and a plurality of first storage portions that respectively store the plurality of first conductors,
wherein each distal end portion of the plurality of first conductors is exposed at the first end surface,
wherein the first end surface is inclined with respect to a plane orthogonal to the first direction, and
wherein the plug is configured to be coupled to the receptacle such that the first direction intersects with a second direction in which the plurality of conductors of the receptacle extends.

14. The plug according to claim 13,
wherein the plurality of first conductors include a plurality of signal conductors and a plurality of ground conductors connected to a ground, and
wherein the plurality of signal conductors and the plurality of ground conductors are arranged so as to be point-symmetric on the first end surface.

15. A receptacle connectable to a plug including a plurality of conductors and exposing each conductor from an end surface, the receptacle comprising:
a plurality of second conductors each extending along a second direction; and
a receptacle housing including a second end surface inclined with respect to a plane orthogonal to the second direction and a plurality of second storage portions that respectively store the plurality of second conductors,
wherein each distal end portion of the plurality of second conductors is exposed at the second end surface,
wherein the second end surface is inclined with respect to a plane orthogonal to the second direction, and
wherein the receptacle is configured to be coupled to the plug such that the second direction intersects with a first direction in which the plurality of conductors of the plug extend.
